(19) United States
(12) Patent Application Publication
(10) Pub. No.: US 2011/0017310 A1
(43) Pub. Date: Jan. 27, 2011

(54) FLUID VALVE ARRANGEMENT

(75) Inventor: Bjorn Eriksson, Linkoping (SE)

Correspondence Address: PARKER-HANNIFIN CORPORATION;HUNTER MOLNAR BAKER MORGAN, 6035 PARKLAND BOULEVARD, CLEVELAND, OH, 44124-4141, US

(73) Assignee: PARKER HANNIFIN AB, BORAS (SE)

(21) Appl. No.: 12/665,744

(22) PCT Filed: Jul. 2, 2007
(86) PCT No.: PCT/SE2007/050485

§ 371 Date: Sep. 17, 2010

(51) Int. Cl. F15D 1/00; F16K 31/12

(52) U.S. Cl. 137/14; 137/487.5

(57) ABSTRACT

The invention relates to a method for controlling a fluid valve arrangement that includes a fluid conduit arrangement having a first conduit and a second conduit, the first and the second conduits being connectable with a fluid consumer; a supply connection arrangement having a pressure connection and a tank connection, and a number of valve arrangement for connecting the consumer to the pressure connection or the tank and a control device, which controls the valve arrangements. The method involves detecting output signals from opening degree sensors connected across at least the first and second valve arrangements to determine the magnitude and direction of a pressure drop across at least the first and second valve arrangements, and using the output signals to determine an operating mode for each valve arrangement.

### CROSS REFERENCE TO RELATED APPLICATION

This application is a continuation of copending International Application PCT/SE2007/050485, filed Jul. 2, 2007, the disclosure of which is incorporated herein by reference in its entirety.

### TECHNICAL FIELD

The invention relates to a fluid valve arrangement comprising a fluid circuit having a first conduit and a second conduit, both conduits being connectable with a fluid consumer, a supply connection arrangement having a pressure connection and a tank connection, a first valve arrangement, which closes the pressure connection or connects it in a controlled manner with the first conduit or the second conduit, a second valve arrangement, which closes the tank connection or connects it in a controlled manner with the first conduit or the second conduit, and a control device, which controls the first valve arrangement and the second valve arrangement.

### BACKGROUND ART

A fluid valve arrangement comprising a control device such as a manually operated lever or a joystick provides is known from U.S. Pat. No. 5,568,759. The control device transmits a specified signal to a microprocessor, which activates pilot valves for both valve arrangements, the spool of said pilot valves being connected via springs with the spool of the valve arrangement concerned, so that a spring-controlled interaction occurs. In many cases, this embodiment is advantageous in that the flow through both valve arrangements takes place only in one direction, so that the forces acting upon the valve elements are substantially independent of the working direction of the consumer. However, it is difficult to achieve an accurate control of the consumer with this valve arrangement, as friction in the mechanical parts, hysteresis in the solenoid valves and external forces, for example forces originating from the flow, prevent an exact positioning of the spool.

The above problem may be solved by a valve arrangement as described in GB 2406363. According to this document, at least one valve arrangement is provided with an opening degree sensor, which is connected with the control device, the control device controlling the valve arrangement in dependence of the signal from the opening degree sensor and a specified signal. By means of the opening degree sensor, the control device can determine the amount of fluid supplied to or discharged by the consumer, depending on whether the opening degree sensor is located in the first or in the second valve arrangement. By means of this opening degree, the movement or the movement speed, respectively, and thus also the position of the consumer, can be controlled relatively accurately.

The valve arrangement has the form of a spool valve, and the opening degree sensor is a position sensor, which determines a position of a spool. Thus, the opening degree is no longer determined directly. A certain opening degree is allocated to each position of the spool, wherein the position of the spool permits an indirect determination of the opening degree. A Hall-sensor, an LVDT (linear variable differential transducer) or any other suitable sensor can be used as position sensor.

The control device considers a non-linear correlation between the position of the spool and the opening degree of the valve arrangement. Such a correlation can, for example, be stored as a function or as a table, so that it is simple for the control device to convert the position of the spool to an opening degree. The control device is connected with at least one pressure difference detection device, which determines a pressure difference across the valve arrangement provided with the opening degree sensor. When the remaining characteristics of the valve arrangement are known, the opening degree and the pressure difference permit the determination of the flow amount. However, the flow amount of the fluid is decisive for the speed, with which the fluid consumer, connected to the conduit arrangement, can be activated. Depending on which valve arrangement is provided with the opening degree sensor and the pressure difference detection device, the inlet (metering-in) or the outlet (metering-out) can be accurately controlled.

According to the document, each conduit is provided with a pressure sensor, each pressure sensor being connected with the control device. This results in further control possibilities. The fluid consumer can be controlled by means of the pressure at the conduits. The pressure sensors form part of the pressure difference detection device. In this way, the pressure sensors have two purposes, that is, the detection of a pressure difference and the detection of an absolute pressure. The control device then detects the pressure difference by means of a third pressure sensor.

A problem with the latter solution is that the function of the arrangement is dependent on pressure sensors. Should a pressure sensor deteriorate over time, the accuracy of the control functions and the reliability of the arrangement will be correspondingly reduced. A further problem is that the arrangement is not optimized for energy efficient operation, such as energy recovery, in order to minimize pressure and flow losses.

### DISCLOSURE OF INVENTION

The above problems have been solved by a method and an arrangement according to the appended claims.

According to one embodiment, the invention relates to a method for controlling a fluid valve arrangement comprising a fluid conduit arrangement having a first conduit and a second conduit, the first and the second conduits being connectable with a fluid consumer; a supply connection arrangement having a pressure connection and a tank connection.

In the subsequent text, the term “fluid” is intended to include both “hydraulic” and “pneumatic”. For instance, the term ‘fluid consumer’ is used as a collective name for all fluid devices, such as piston-cylinder arrangements and fluid motors that may be operated either hydraulically or pneumatically using this method.

A first valve arrangement is operable to accomplish at least one of closing the pressure connection and connecting the pressure connection in a controlled manner with the first conduit, and a second valve arrangement is operable to accomplish at least one of closing the pressure connection and connecting the pressure connection in a controlled manner with the first conduit. Hence, the first and second conduits may be connected to a first and second fluid connection of the fluid consumer, for instance, in order to move a piston in a desired direction using pressure from the pressure connection. The pressure connection may be a fixed or variable displacement fluid pump, an accumulator or a similar suitable source of pressure.

In addition, a third valve arrangement is operable to accomplish at least one of closing the tank connection and connecting the tank connection in a controlled manner with the first conduit, and a fourth valve arrangement is operable to accomplish at least one of closing the tank connection and connecting the tank connection in a controlled manner with the second conduit. A control device is provided for controlling the valve arrangements.

The method according to the invention may involve the steps of
detecting output signals from opening degree sensors connected across at least the first and second valve arrangements
transmitting the output signals to the control device, which control device is arranged for controlling the valve arrangements in response to signals received from each opening degree sensor
determining the magnitude and direction of a pressure drop across at least the first and second valve arrangements, using the said output signals,
determining if the pressure in the pressure connection is sufficient for actuating the fluid consumer, and, if the pressure is insufficient, increasing the pressure in the pressure connection, and
determining if the pressure in the conduit to be drained from the fluid consumer is greater than the pressure in the pressure connection, and, if the pressure from the fluid consumer is greater, returning fluid to the pressure connection during actuating the fluid consumer.

The magnitude and direction of said pressure drop may be determined using an opening degree sensor in a constant pressure valve connected across said valve arrangements, in particular by detecting the position of a spool or spool in the constant pressure valve. The control device may be used for evaluating a non-linear correlation between the position of the spool and the opening degree of the valve arrangement.

Further the method involves determining an operating mode for each valve arrangement based on the output signals from the opening degree sensors and an input signal from a control unit for the fluid consumer. The said operating modes will be discussed in further detail below.

The invention also relates to a fluid valve arrangement comprising a fluid conduit arrangement having a first conduit and a second conduit, the first and the second conduits being connectable with a fluid consumer. The fluid valve arrangement further comprises a supply connection arrangement, having a pressure connection, and a tank connection. As stated above the source of pressure may be a fixed or variable displacement fluid pump, an accumulator or a similar device. Further, a first valve arrangement is operable to accomplish at least one of closing the pressure connection and connecting the pressure connection in a controlled manner with the first conduit, and a second valve arrangement is operable to accomplish at least one of closing the pressure connection and connecting the pressure connection in a controlled manner with the second conduit.

A third valve arrangement is operable to accomplish at least one of closing the tank connection and connecting the tank connection in a controlled manner with the first conduit, and a fourth valve arrangement is operable to accomplish at least one of closing the tank connection and connecting the tank connection in a controlled manner with the second conduit. The third and fourth valve arrangements are arranged to connect their respective exit port on the fluid consumer to a drain or tank when the fluid consumer is driven by the pressure conduit, either via the first or second conduits.

The above valve arrangements are connected to a control device, which may transmit output signals to control each individual valve arrangement. At least the first and the second valve arrangement is provided with at least one opening degree sensor connected with the control device, and that the control device is operable to control the valve arrangements in response to signals received from each opening degree sensor which signals are proportional to the magnitude and direction of a pressure drop across at least the first and second valve arrangements.

Each opening degree sensor may be part of a constant pressure valve connected by fluid conduits across said at least the first and second valve arrangements. The constant pressure valve may comprise a spool valve and the opening degree sensor is a position sensor, which determines a position of a spool in said spool valve. In this way the pressure in the conduits on either side of each valve arrangement may act on either end of a spool valve that is spring loaded towards a neutral, central position. The control device may then be used for evaluating a non-linear correlation between the position of the spool and the opening degree of the valve arrangement.

In this way the output signal from each opening degree sensor allows the control device to determine the magnitude and direction of a pressure drop across at least the first and second valve arrangements. For instance, the control device may determine that the pressure in the first or second conduit is greater than the pressure in the supply connection. Depending on the desired direction of operation of the fluid consumer, the first or the second valve arrangement can be controlled to select a regenerative mode during operation of the fluid consumer. This allows a relatively higher pressure from the fluid consumer to be regenerated by opening a suitable valve in the first or the second valve arrangement and returning pressurized fluid to the pressure connection.

According to one example, the fluid valve arrangement as described above is provided with opening degree sensors for each of the third and fourth valve arrangements, which sensors are connected with the control device. Each opening degree sensor may be part of a constant pressure valve connected across said third and fourth valve arrangements.

In order to perform the operations outlined above, each of the first to the fourth valve arrangement comprises a first controllable valve operable to allow fluid flow to the fluid consumer, and a second controllable valve operable to allow fluid flow from the fluid consumer. According to one example the controllable valves may be solenoid operated two-way valves connected to the control device.

According to a further example, at least the first and the second valve arrangement each comprise a valvistor® ®, connecting the fluid consumer to the supply connection.

In the subsequent text, the term “valvistor®” is used for a pressure controlled valve, which valve has an embedded internal hydraulic feedback that provides an efficient, flow-force compensated, proportional flow valve. The valve uses a small pilot circuit to drive the larger main flow, similar to the behaviour of an electronic transistor; hence the name. A basic version of this type of valve was developed by Bacho Hydrauto AB. Other advantages to this type of valve include a fast response, repeatability, and low hysteresis. One example of a valvistor® ® type pressure controlled valve as used by the current invention is described in the EP Patent Application No. 06120006.

The pressure controlled valve, or valvistor® ® described in EP 0620006 comprises a first valve port connected to a source of fluid pressure and a second valve port connected to a first chamber of the consumer. Further, the valve comprises a valve cone slidably movable in a cavity in a valve body, between a first position in which a connection between the first and second valve ports is closed by a first side of the valve cone, and a second position in which the connection between the first and second valve ports is open. The cone is being urged to its closed position by fluid pressure acting on an opposite, second side of the valve cone, which second side forms a space within the valve body. In addition the valve body may comprise means for passing fluid under pressure through the valve cone from the first and second valve ports to said space through passages each containing a non-return valve. Controllable valve means are provided for connecting said space with the first and the second valve ports, respectively.

The controllable valve means comprise a first pilot valve in a conduit connecting said space with the first valve port. The first pilot valve is arranged to be actuated to allow a fluid flow from the second valve port to the first valve port, if the pressure in the second valve port exceeds that of the first valve port. The controllable valve further comprises a second pilot valve in a conduit connecting said space with the second valve port. The second pilot valve can be actuated to allow a fluid flow from the first valve port to the second valve port, if the pressure in the first valve port exceeds that of the second valve port.

The function of the pressure controlled valve, or valvistor® ®, according to the invention will be described in further detail below (see FIG. 3).

The valvistor® ® has a first and a second pilot circuit each comprising a pilot valve and an opening degree sensor connected across the pilot valve. The opening degree sensor is connected with the control device, and the control device is operable to control the pilot valves in response to signals received from each opening degree sensor. As stated above, the signals are proportional to the magnitude and direction of a pressure drop across at least the first and second pilot valves. Each opening degree sensor may be part of a constant pressure valve connected across said at least the first and second valve arrangements.

In addition, each of the third and fourth valve arrangements may also be provided with a valvistor®, connecting the fluid consumer to the tank connection, which valvistor® has a first and a second pilot circuit each comprising a pilot valve and an opening degree sensor connected with the control device.

The above embodiments may use a constant pressure valve that operates in one or both directions, having the ability to control the pressure drop across a valve or flow restrictor, irrespective of the direction of flow of fluid fluid.

By using a sensor for measuring the position of a spool in the constant pressure valve it is possible to derive information about the pressure drop across the valve or flow restrictor. From this information it is possible to identify different operating modes. In this way it is possible to determine the most energy efficient method of operation for the system, in order to minimize pressure and flow losses. A Hall-sensor, an LVDT (linear variable differential transducer) or any other suitable sensor can be used as position sensor.

In a two-way valve of the valvistor® type using conventional pilot constant pressure valves the position of the spool in each constant pressure valve is measured. As described above, this information can be used for determining possible operating modes and pressure drops across relevant valves.

Using the information containing the data relating to the position of the constant pressure valves it is possible to determine not only the operating mode, but also the pressure required for controlling the load on the system. As described above, this prevents the fluid consumer from being connected to the supply connection when the supplied pressure is insufficient for driving the fluid consumer.

The constant pressure valve may comprise a spool valve and the opening degree sensor is a position sensor, which determines a position of a spool in said spool valve. In this way the pressure in the conduits on either side of each valve arrangement may act on either end of a spool valve that is pre-loaded by a spring means towards a neutral, central position. When the pressure drop across the pressure compensated valve becomes greater than the corresponding pre-load of a coil spring, or a similar spring means, the constant pressure valve will begin to throttle the flow in order to maintain a constant pressure drop across the pressure compensated valve. This constant pressure drop is about equal to the preload on the spring. The valve arrangement allows for flow compensation in both directions.

By measuring the position for the compensator of each directional valve in the system the controller receives information that allows it to determine which valves should and could be used for performing a particular displacement of a load. By controlling the positions of the constant pressure valves according to the strategy outlined below, the pressure losses in the system will be minimized. As described above, the valves may either be valves having a two-way constant pressure valve or be of the valvistor® type using double pilot pressure circuits. In both cases the position of the constant pressure valve is measured. The regulator, or control device, can receive the same input signals, representing compensator positions, and may transmit the same control signals, representing valve control signals, to other fluid loads in the system.

A further advantage is that the use of constant pressure valve in the hardware of the fluid arrangement, a certain amount of redundancy is built into the system. Consequently, the system may be controlled in a conventional manner even if one or more position sensors should fail.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic diagram of a fluid arrangement according to one embodiment of the invention;

FIG. 2 shows a fluid arrangement according to a first example of the arrangement in FIG. 1;

FIG. 3 shows a fluid arrangement according to a second example of the arrangement in FIG. 1;

FIG. 4 shows an enlarged view of a valve arrangement according to FIG. 2; and

FIG. 5 shows an enlarged view of a valve arrangement according to FIG. 3.

### EMBODIMENTS OF THE INVENTION

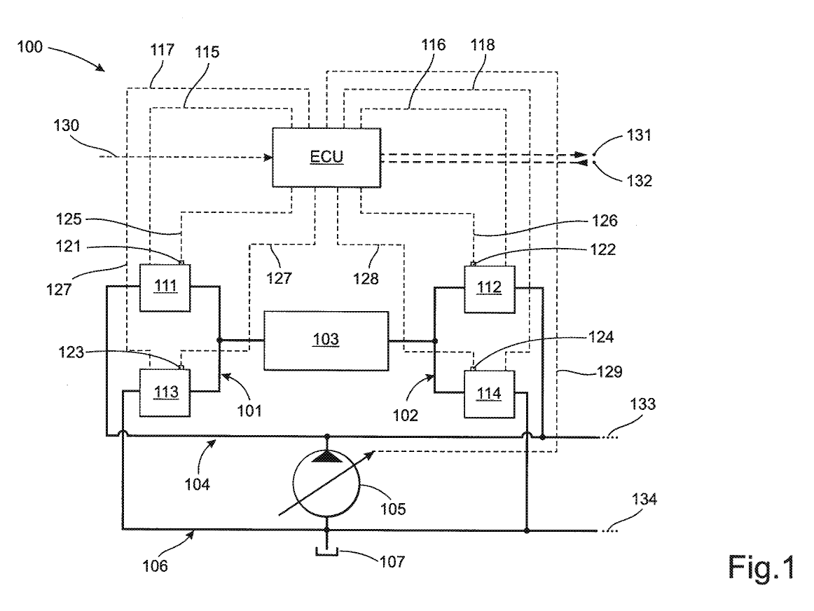

FIG. 1 shows a schematic diagram of a fluid arrangement 100 according to one embodiment of the invention. The fluid valve arrangement shown comprises a fluid conduit arrangement having a first conduit 101 and a second conduit 102, the first and the second conduits 101, 102 being connectable with a fluid consumer 103. The fluid valve arrangement further comprises a supply connection arrangement, having a pressure connection 104 supplied by a controllable pump 105, and a tank connection 106 for draining fluid to a tank 107. In this example, the source of pressure is a variable displacement fluid pump 105. Further, a first valve arrangement 111 is operable to accomplish at least one of closing the pressure connection 104 and connecting the pressure connection 104 in a controlled manner with the first conduit 101, and a second valve arrangement 112 is operable to accomplish at least one of closing the pressure connection 104 and connecting the pressure connection 104 in a controlled manner with the second conduit 102.

A third valve arrangement 113 is operable to accomplish at least one of closing the tank connection 106 and connecting the tank connection 106 in a controlled manner with the first conduit 101, and a fourth valve arrangement 114 is operable to accomplish at least one of closing the tank connection 106 and connecting the tank connection 106 in a controlled manner with the second conduit 102. The third and fourth valve arrangements 113, 114 are arranged to connect the fluid consumer 103 to the tank 107 when the fluid consumer 103 is driven by fluid from the pressure conduit 104, either via the first or second conduits 101, 102.

The above valve arrangements are connected to a control device in the form of an electronic control unit ECU, which may transmit control signals 115-118 to control each individual valve arrangement 111-114, respectively. Each valve arrangement 111-114 is further provided with a respective opening degree sensor 121-124, respectively. The opening degree sensors 121-124 are connected with the control device ECU, which receives output signals 125-128 from the respective opening degree sensor 121-124. Upon receipt of a control signal, the control device ECU is operable to control the valve arrangements 111-114 in response to the signals 125-128 received from each opening degree sensor 121-124, which signals are proportional to the magnitude and direction of a pressure drop across the respective valve arrangement 111-114.

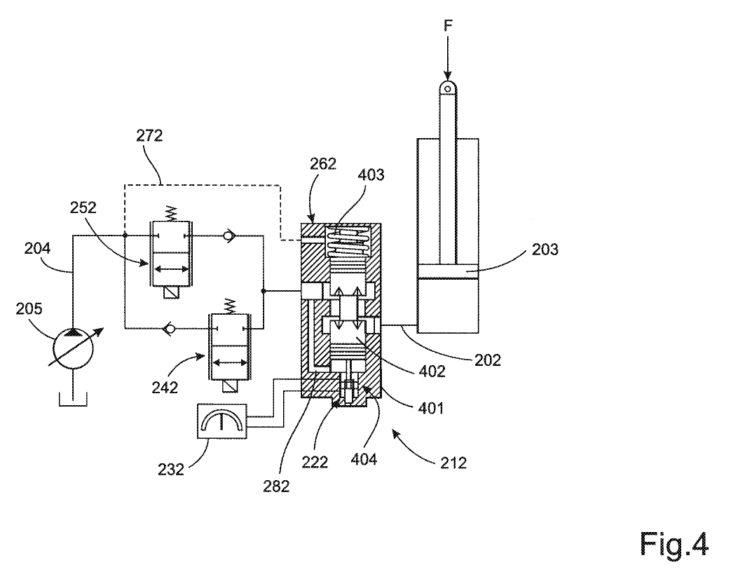

Each opening degree sensor 121-124 is part of a one-way or bi-directional constant pressure valve that is part of the first, second, third and fourth valve arrangements 111-114. An example of a bi-directional constant pressure valve is shown in FIG. 4. The constant pressure valve controls the flow through the respective valve arrangements in response to fluid pressure in pilot conduits across the valve arrangement. As shown in FIG. 4, the constant pressure valve may comprise a spool valve and the opening degree sensor is a position sensor, which determines a position of a spool in said spool valve. In this way the pressure in the conduits on either side of each valve arrangement may act on either end of a spool valve that is spring loaded towards a neutral, central position. The constant pressure valve may comprise a spool valve and the opening degree sensor is a position sensor, which determines a position of a spool in said spool valve. In this way the pressure in the conduits on either side of each valve arrangement may act on either end of a spool valve that is pre-loaded by a spring means towards a neutral, central position. When the pressure drop across the pressure compensated valve becomes greater than the corresponding pre-load of a coil spring, or a similar spring means, the constant pressure valve will begin to throttle the flow in order to maintain a constant pressure drop across the constant pressure valve. This constant pressure drop is about equal to the preload on the spring. The valve arrangement allows for flow compensation in both directions. The control device ECU can then be used for evaluating a non-linear correlation between the position of the spool and the opening degree of the valve arrangement.

In FIG. 1, the output signals 125-128 from each opening degree sensor 121-124 allows the control device ECU to determine the magnitude and direction of a pressure drop across at least the first and second valve arrangements 111-114. For instance, assume that it is desired to drive a fluid flow through the fluid consumer 103 from left to right as seen in FIG. 1, but that there is no information available with respect to the load acting on the fluid consumer. By determining the positions of the spools in the constant pressure valves it is possible to ascertain which valves are possible to open to achieve a fluid flow in the desired direction. In this case, it must be decided which one of the first valve arrangement 111 or the third valve arrangement 113 that can deliver fluid to the system, and which one of the second valve arrangement 112 or the fourth valve arrangement 114 that can receive fluid from the fluid consumer 103. The goal is to minimize the amount of energy required to perform work and if possible return energy, in the form of pressurized fluid, from the load to the system. The control strategy can be as follows.

First, if the opening degree sensor 122 of the constant pressure valve in the second valve arrangement 112 indicates that the pressure drop over the constant pressure valve is sufficient from the fluid consumer 103 to the pressure connection 104, then the third valve arrangement 113 is opened fully from the tank 107 to the fluid consumer 103. The second valve arrangement 112 is then used for controlling a desired rate of fluid flow from the fluid consumer 103 to the pressure connection 104. In this mode, the load can regenerate energy back to the system.

Second, if the pressure drop across the second valve arrangement 112 is reduced or is lost, this is indicated by the opening degree sensor 122 of the constant pressure valve in the second valve arrangement 112. This will cause the second valve arrangement 112 to close. If the opening degree sensor 124 of the constant pressure valve in the fourth valve arrangement 114 indicates that the pressure drop over the constant pressure valve is sufficient from the fluid consumer 103 to the tank 107, then the fourth valve arrangement 114 is used to control the fluid flow from the fluid consumer 103 and return it to the tank 107. In this mode, there is no regeneration.

Third, if the pressure drop across the fourth valve arrangement 114 is reduced or is lost, this is indicated by the opening degree sensor 124 of the constant pressure valve in the fourth valve arrangement 114. This will cause the fourth valve arrangement 114 to close. In this mode, the load on the fluid consumer 103 is no longer able to drive fluid flow through the system in the desired direction. This will also cause the third valve arrangement 113, connecting the tank 107 to the fluid consumer 103 during the second mode, to close. In this mode, fluid under pressure must be supplied to continue driving a fluid flow in the desired direction. This is achieved by controlling the first valve arrangement 111 to supply a desired rate of fluid flow from the pressure connection 104 to the fluid consumer 103.

Fourth, it is desired to maintain the pressure at the fluid return side of the load, so that regeneration of energy to the pressure connection 104 can be performed whenever possible. This is achieved by controlling the second valve arrangement 112 and the fourth valve arrangement 114, by means of regulators using the output of the opening degree sensor 122 of the constant pressure valve in the first valve arrangement 111 as a target to minimize the pressure drop across the first valve arrangement 111. By selecting different reference values for each regulator, regeneration of fluid pressure to the pressure connection 104 can be given a higher priority.

The four modes described above may be divided into two main modes, that is, meter-in and meter-out modes. Meter-out relates to a mode where the return flow from the fluid consumer is used for controlling the load. The load ca be said to be driving itself, without using energy from the high pressure side of the system. Meter-in relates to a mode where energy from the high pressure side of the system is used for driving the load. The example in FIG. 1 illustrates general valve arrangements, where different electrically controlled valves can be used for controlling different directions of flow. For instance, a valve arrangement with a one-way constant pressure valve can comprise two separate pilot valves; one for each direction of fluid flow. Each pilot valve will act as a non-return valve in the direction of fluid flow opposite to that for which it is intended. This particular function is utilized in the third and fourth modes described above. Alternatively, a bi-directional constant pressure valve can use a pair of controllable valves with associated non-return valves connected in parallel, as shown in FIG. 4.

In addition, the controllable pump 105 is controlled in response to the positions of the opening degree sensors 121-124 of the constant pressure valves, in the same way as the valve arrangements 111-114. In the above example, only loads actuated during the fourth mode are used for controlling the pump 105. The reason for this is that only the load demanding the highest pressure is to be used for controlling the pump. The largest load is selected by monitoring the opening degree sensors of the constant pressure valves in operation during the fourth mode. The constant pressure valve having the largest opening degree, and consequently the lowest pressure drop, will be used as a reference value for a regulator controlling the pump 105. The pump 105 will then be controlled so that a minimal pressure drop is maintained over the valve arrangement having the lowest pressure drop.

The control unit ECU can also use the output signals 125-128 from each opening degree sensor 121-124 to determine if the pressure in the pressure connection 104 is sufficient for actuating the fluid consumer 103 in response to a control signal from an operator. If the pressure is insufficient, the control unit ECU will transmit an output signal 129 to the pump 105 to increase the pressure in the pressure connection 104. This safety function prevents the fluid consumer 103 from being connected to the supply connection 104 when the supplied pressure is insufficient for driving the fluid consumer 103.

The fluid consumer 103 is operated by the control unit ECU in response to an input signal 130 from an operator. The control unit ECU may also transmit and receive signals 131, 132 from other fluid loads or fluid consumers operable in conjunction with the fluid consumer 103 shown. Similarly, the pump 105 and the tank 107 can be connected to additional fluid loads and drains 133, 134 for supplying pressure and receiving fluid fluid, respectively, in the same way as described above.

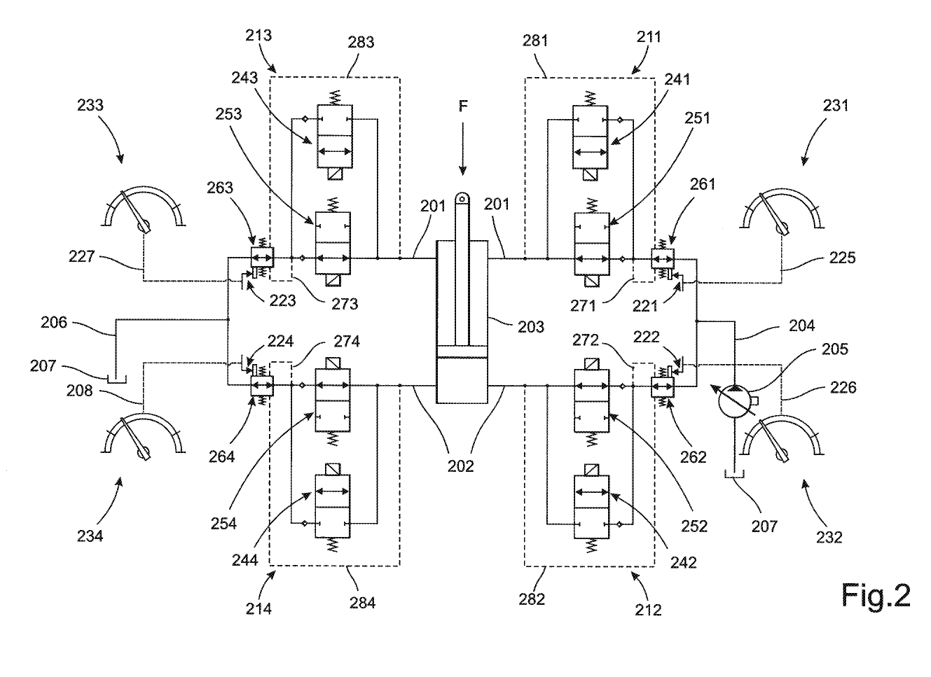

FIG. 2 shows a fluid arrangement 200 according to a first example of the embodiment illustrated in FIG. 1. Hence, the fluid valve arrangement 200 comprises a first conduit 201 and a second conduit 202, the first and the second conduits 201, 202 being connectable with a first and a second chamber on opposite sides of a piston in a fluid cylinder 203. The first and the second conduits 201, 202 are both shown as two separate conduits on either side of the upper and lower sections of the cylinder for reasons of clarity. The two first and the two second conduits 201, 202 would in fact be connected to the same respective port on the cylinder 203, as indicated by the conduits 101, 102 in FIG. 1.

The fluid valve arrangement further comprises a pressure connection 204 supplied by a controllable pump 205, and a tank connection 206 for draining fluid to a tank 207. As in FIG. 1, a first valve arrangement 211 is operable to accomplish at least one of closing the pressure connection 204 and connecting the pressure connection 204 in a controlled manner with the first conduit 201, and a second valve arrangement 212 is operable to accomplish at least one of closing the pressure connection 204 and connecting the pressure connection 204 in a controlled manner with the second conduit 202.

A third valve arrangement 213 is operable to accomplish at least one of closing the tank connection 206 and connecting the tank connection 206 in a controlled manner with the first conduit 201, and a fourth valve arrangement 214 is operable to accomplish at least one of closing the tank connection 206 and connecting the tank connection 206 in a controlled manner with the second conduit 202. The third and fourth valve arrangements 213, 214 are arranged to connect the fluid consumer 203 to the tank 207 when the fluid consumer 203 is driven by fluid from the pressure conduit 204, either via the first or second conduits 201, 202.

Each valve arrangement 211-214 further comprises a first and a second controllable valve 241-244, 251-254. The first and second valve arrangements 211, 212 each comprise a first and a second controllable valve 241, 242 and 251, 252, respectively, connected in parallel between the pump and the cylinder. Similarly, the third and fourth valve arrangements 213, 214 each comprise a first and a second controllable valve 243, 244 and 253, 254, respectively, connected in parallel between the tank and the cylinder. In the example in FIG. 2, the first valve arrangement 211 comprises a first solenoid controlled two-way valve 241. The first two-way valve 241 is spring loaded to a closed position and is provided with a non-return valve that allows fluid flow towards the cylinder 203 during actuation of the two-way valve 241. A second two-way valve 251 is spring loaded to a closed position and is provided with a non-return valve that allows fluid flow towards the pump 205 during actuation of the two-way valve 251. The second valve arrangement 212 is identical to the first valve arrangement 211. Similarly, the third and fourth valve arrangements 213, 214 are of the same design and perform the same function in the fluid conduits 201, 202 between the cylinder 203 and the tank 207.

The above valve arrangements are connected to a control device (not shown), which may transmit control signals to control each individual valve arrangement 211-214, respectively. Each valve arrangement 211-214 is further provided with a respective opening degree sensor 221-224, respectively. The opening degree sensors 221-224 are connected with the control device, which receives output signals 225-228 from the respective opening degree sensor 221-224. Upon receipt of a control signal, the control device is operable to control the valve arrangements 211-214 in response to the signals 225-228 received from each opening degree sensor 221-224, which signals are proportional to the magnitude and direction of a pressure drop across the respective valve arrangement 211-214. Each opening degree sensor 221-224 is part of a constant pressure valve 261-264 (see FIG. 4) that is part of the first, second, third and fourth valve arrangements 211-214. The constant pressure valve controls the flow through the respective valve arrangements in response to fluid pressure in pilot conduits 271-274, 281-284 across the valve arrangement.

In the example in FIG. 2, the first valve arrangement 211 comprises a first constant pressure valve 261. One end of a spool valve in the constant pressure valve (see FIG. 4) is connected to the pressure connection 204 via a first pilot conduit 271. The opposite end of the spool valve in the constant pressure valve 261 is connected to the first conduit 201 via a second pilot conduit 281. The second valve arrangement 212 comprises a first pilot conduit 272 and a second pilot conduit 282 connected in the same way between the pressure connection 204 and the second conduit 202. Similarly, the third valve arrangement 213 comprises a first pilot conduit 273 and a second pilot conduit 283 connected between the tank connection 206 and the first conduit 201. The fourth valve arrangement 214 comprises a first pilot conduit 274 and a second pilot conduit 284 connected between the tank connection 206 and the second conduit 202. This allows the opening degree sensors 221-224 to monitor the magnitude and direction of said pressure drop across each respective valve arrangement at all times.

FIG. 4 shows a partially enlarged view of the second valve arrangement 212. In FIG. 4, the constant pressure valve 262 comprises a spool valve 401 and the opening degree sensor 222 comprises a position sensor 404, which determines a position of a spool 402 in said spool valve 401. A certain opening degree is allocated to each position of the spool 402, wherein the position of the spool 402 permits an indirect determination of the opening degree. A Hall-sensor, an LVDT (linear variable differential transducer) or any other suitable sensor can be used as position sensor 404. The control device considers a non-linear correlation between the position of the spool 402 and the opening degree of the valve arrangement. Such a correlation can, for example, be stored as a function or as a table, so that it is simple for the control device to convert the position of the spool 402 to an opening degree. The direction of movement of the spool 402 indicates the direction of a pressure drop across the valve arrangement 202. Also, the magnitude of the degree of opening, as indicated by the distance the spool 402 is displaced from its neutral position gives an indication of the magnitude of the pressure across the valve arrangement 202.

In this way the pressure in the pilot conduits 272, 282 on either side of the valve arrangement 212 can act on either end of the spool 402 that is spring loaded by a coil spring 403, or a similar spring means, towards a neutral, central position. When the pressure drop across the constant pressure valve becomes greater than the corresponding pre-load of the coil spring 403, the spool 402 is displaced and the constant pressure valve will begin to throttle the flow in order to maintain a constant pressure drop across the constant pressure valve. This constant pressure drop is about equal to the preload on the spring 403. The valve arrangement allows for flow compensation in both directions. The control device can then be used for evaluating a non-linear correlation between the position of the spool and the opening degree of the valve arrangement.

The magnitude and direction of said pressure drop across each respective valve arrangement is schematically indicated by pressure gauges 231-234 in FIG. 2. When the pressure in, for instance, the first conduit 201 is equal to the pressure in the pressure connection 204, the constant pressure valve will assume its neutral position. An indicator needle in the virtual pressure gauge 231 would indicate this state by assuming a substantially vertical position. This particular state is shown by the pressure gauge in FIG. 4. If the pressure in the pressure connection 204 is higher than the pressure in the first conduit 201, the direction and size of the deviation of the indicator needle from the vertical position indicates the magnitude and direction of the pressure drop across the first valve arrangements 211.

The position signal from each respective opening degree sensor 221-224 is proportional to the said pressure drop allows the control unit to determine which valves to open or close, or whether pump actuation is required, when controlling the cylinder 203 in response to a control signal from an operator. The control unit may also transmit and receive signals from other fluid loads or fluid consumers operable in conjunction with the fluid consumer 203 shown. Similarly, the pump 205 and the tank 207 can be connected to additional fluid loads and drains for supplying pressure and receiving fluid fluid, respectively, in the same way as described above.

The example in FIG. 2 can be modified by replacing each two-way valve by a single three-way valve with non-return valves and a closed centre. This would not affect the position sensing function of a bi-directional constant pressure valve connected across the valve. Alternatively, a constant pressure valve allowing flow in one direction only can be connected across each two-way valve making up a valve arrangement. In the latter case, the control unit will receive one signal from each position sensor and will be required to compare the signals to determine the direction of the pressure drop across the valve arrangement.

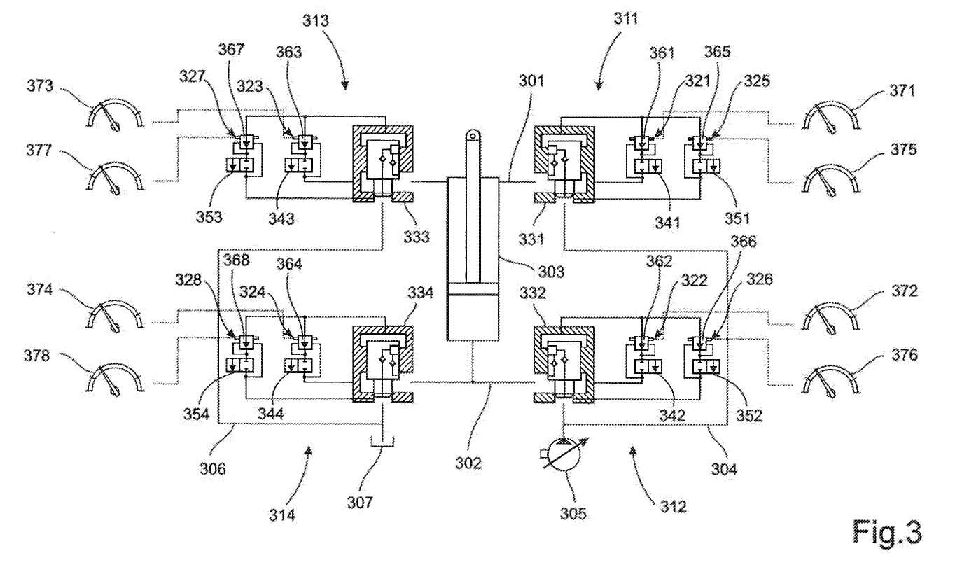

FIG. 3 shows a fluid arrangement 300 according to a second example of the embodiment illustrated in FIG. 1. Hence, the fluid valve arrangement 300 comprises a first conduit 301 and a second conduit 302, the first and the second conduits 301, 302 being connectable with a first and a second chamber on opposite sides of a piston in a fluid cylinder 303. The first conduit 301 is shown as two separate conduits on either side of the upper section of the cylinder for reasons of clarity. The two first conduits 301 would in fact be connected to the same respective port on the cylinder 303, as indicated by the conduit 302.

The fluid valve arrangement further comprises a pressure connection 304 supplied by a controllable pump 305, and a tank connection 306 for draining fluid to a tank 307. As in FIG. 1, a first valve arrangement 311 is operable to accomplish at least one of closing the pressure connection 304 and connecting the pressure connection 304 in a controlled manner with the first conduit 301, and a second valve arrangement 312 is operable to accomplish at least one of closing the pressure connection 304 and connecting the pressure connection 304 in a controlled manner with the second conduit 302.

A third valve arrangement 313 is operable to accomplish at least one of closing the tank connection 306 and connecting the tank connection 306 in a controlled manner with the first conduit 301, and a fourth valve arrangement 314 is operable to accomplish at least one of closing the tank connection 306 and connecting the tank connection 306 in a controlled manner with the second conduit 302. The third and fourth valve arrangements 313, 314 are arranged to connect the fluid consumer 303 to the tank 307 when the fluid consumer 303 is driven by fluid from the pressure conduit 304, either via the first or second conduits 301, 302.

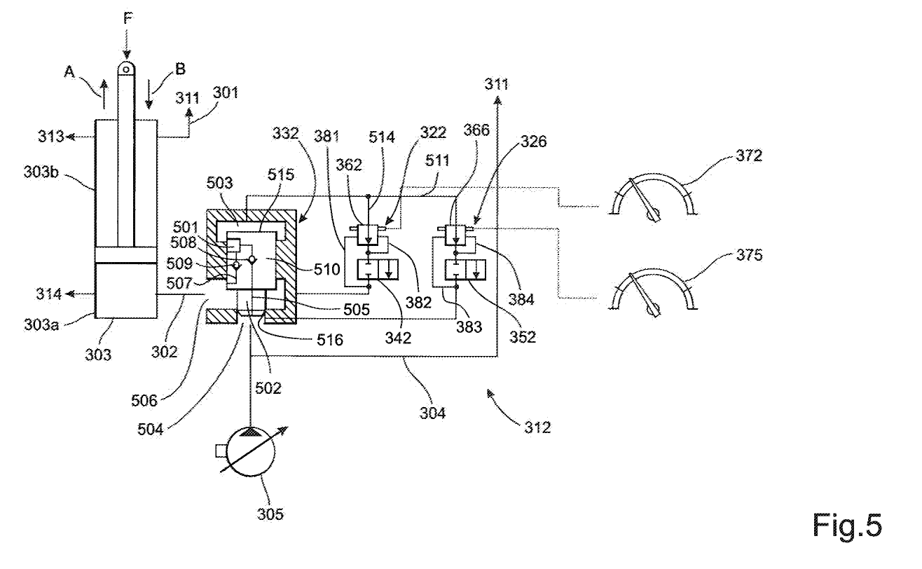

Each valve arrangement 311-314 comprises a valvistor® 331-334 provided with a first and a second controllable pilot valve 341-344, 351-354 respectively. A constant pressure valve 361-364, 365-368 provided with an opening degree sensor 321-324, 325-328 is connected across each pilot valve 341-344, 351-354. In this example, the constant pressure valves are of the one-way type, as each pilot valve handles flow in one direction only. The function of such a valvistor® and its associated pilot valves is described in connection with FIG. 5 below. FIG. 5 shows an enlarged view of the second valve arrangement 312. The second valve arrangement 312 is identical to the first valve arrangement 311. The third and fourth valve arrangements 313, 314 are of the same design and perform the same flow controlling function in the fluid conduits 301, 302 between the respective ports of the cylinder 303 and the tank 307.

The above valve arrangements are connected to a control device (not shown), which may transmit control signals to control each individual valve arrangement 311-314, respectively. Each opening degree sensor 321-324, 325-328 in their respective constant pressure valve 361-364, 365-368 is connected with the control device, which receives output signals from the respective opening degree sensor 321-324, 325-328. The output signals indicate the position of a spool in the constant pressure valves, which position signals are proportional to the magnitude and direction of the pressure drop across each respective pilot valve 341-344, 351-354. This is schematically indicated by pressure gauges 371-374; 375-378 in FIG. 3.

Upon receipt of a control signal, the control device is operable to control the valve arrangements 311-314 in response to an operator control signal and the signals received from each opening degree sensor 321-324, 325-328, which signals are proportional to the magnitude of a pressure drop across the pilot valves in the respective valve arrangement 311-314.

FIG. 5 shows an enlarged view of the second valve arrangement 312 of FIG. 3, which arrangement comprises a valvistor® 332. In this valvistor® 332, a groove 501 serving as a variable restriction is formed in the mantle surface of a valve cone 502, said groove 501 is connected to a pilot flow chamber 503 in the closed position of the valve cone 502. This groove 501 is also in fluid connection a valve port 504 through a pilot flow passage 505 made in the valve cone 502, and with the valve port 506 through a pilot flow passage 507 also made in the valve cone 502, each of these passages 505, 507 being provided with a non-return valve 508 and 509, respectively, which permit pressurized fluid to flow from the valve port 504 and the valve port 506, respectively, to the groove 501 serving as a variable restriction and through this to the space 503 but prevent a flow in opposite direction.

The space 503 serving as pilot flow chamber in the valvistor® body 510 is in turn connected with the valve ports 504 and 506. A first pilot flow passage 511 is provided between the space 503 and the first valve port 504 via the pressure connection 304 connected to the pump 305. In the pilot flow passage 511 there is arranged a solenoid actuated first pilot valve 352. This valve may be an electrically operated solenoid valve, or a proportional magnet valve which is controlled steplessly between its two end positions. The first pilot valve 352 can be moved between a non-actuated closed and an actuated open position. In this example the pilot valves are a solenoid actuated two-way or 2-port valves which are spring loaded towards a closed position. In the closed position the first pilot valve 352 prevents outflow of pressurized fluid from the space 503. A second pilot flow passage 514 is provided between the space 503 and the second valve port 506. In the pilot flow passage 514 there is arranged a solenoid actuated second pilot valve 342. The second pilot valve 342 can be moved between a non-actuated closed and an actuated open position. In the closed position the second pilot valve 342 prevents outflow of pressurized fluid from the space 503.

In the above arrangement, the pressure in the space 503 will be the same as in the first valve port 504 or in the second valve port 506 depending on which port has the highest pressure. More specifically, the pressure in the space 503 will be the same as the pressure upstream of the valve cone 502 as seen in the direction of flow, irrespective of which valve port 504, 506 is operated as input, as the pressure is always higher on the input side than on the output side. This pressure prevailing in the space 503 gives rise to a holding force acting on the end surface 515 of the valve cone 502 which is greater in dependence on the area ratio than the counter-directed pressure dependent on the port 504, 506 operating as input and acting on at least a part of the conical end surface 516 of the valve cone. Consequently the pressure prevailing in the space 503 holds the valve cone 502 in its closed position as long as the pilot valves 352, 342 are closed.

When, for instance, the first pilot valve 352 is opened a pilot flow will arise from the space 503 via the pilot flow passage 511, to a position downstream the valve port serving as output, i.e. the port 504 in this case. Consequently the valve cone 502 is made to move from its closed position and to open the connection through the valve body 510, and the valve cone 502 is then made to move as far from its closed position as required to establish a flow balance between the flow through the valve cone 502 and the flow through the control pilot valve 352. By the stepless control offered by said pilot valve 352 the valve cone 502 is also controlled steplessly between its end positions and a possibility is consequently obtained in this way to control the speed of the piston in the cylinder 303.

A one-way constant pressure valve 362, 366 is connected across each pilot valve 342, 352, via conduits 381, 382 and 383, 384 connected to the respective pilot conduit 514, 511 upstream and downstream of each pilot valve 342, 352. The opening degree sensor 322, 326 in each constant pressure valve 362, 366 is arranged to transmit a position signal to an electronic control unit (not shown). The position signals indicate the position of a spool in the respective constant pressure valve 362, 366 and allows the control unit to determine the magnitude of the pressure drop across each pilot valve 342, 352. Each valve arrangement 311-314 in FIG. 3 is provided with a valvistor 331-334 as described above. The first valve arrangement 311 has its corresponding valve port 504 of the valvistor® 331 connected to the pressure connection 304, in the same way as in the second valve arrangement 312. In the third and fourth valve arrangements 313, 314, the corresponding valve ports 504 of the valvistor® 333, 334 are connected to the tank connection 306. As stated above, each opening degree sensor 321-324; 325-328 is part of a constant pressure valve 361-364; 365-368 that is part of the first, second, third and fourth valve arrangements 311-314. The constant pressure valve controls the flow through the respective valve arrangements in response to fluid pressure in pilot conduits across the valve arrangement. Consequently, the control unit can control the fluid cylinder in response to an input signal by an operator by controlling each valvistor® 331-334, which valvistor®s are in turn controlled by opening and closing the respective pilot valves. The control of the pilot valves and/or the pressure delivered by the pump is determined by the sensed pressure drop across each pilot valve.

In order to actuate the cylinder 303 in the direction of the arrow A against the action of a load F, as shown in FIG. 3, the pump 305 is controlled to supply pressurized fluid. As long as the first and second pilot valve 352, 342 are maintained closed, the valve cone 502 is also kept in closed position as the pressure in the valve port 504 serving as input and in the space 503 is the same. If the control unit, using the position signal of the opening degree sensor 322, determines that the pressure in the pilot conduit 514 is higher than the pressure in the second valve port 506, then the second pilot valve 342 may be opened. When the second pilot valve 342 is actuated a pilot flow arises from the space 503 behind the valve cone 502 towards the second valve port 506 serving as output. Provided that the pressure in the first valve port 504 is higher than that of the second valve port 506, this pilot flow causes the valve cone 502 to move from its closed position and to open the valve. This allows pressurized fluid to flow directly from the first valve port 504 to the second valve port 506 into a first chamber 303a of the cylinder 303 which is then actuated to work against a load F. The above arrangement provides a fail-safe function that prevents the valve arrangement 312 from opening unless the pressure supplied from the pump 305 is higher than the pressure in the first chamber 303a of the cylinder 303.

In order to actuate the cylinder 303 in the direction of the arrow B, two modes of operation are possible. In a first mode the pump 305 is used for regenerating pressurized fluid from the first chamber 303a of the cylinder 303. As long as the first and second pilot valve 352, 342 are maintained closed, the valve cone 502 is also kept in closed position as the pressure in the valve port 504 serving as input and in the space 503 is the same. When the first pilot valve 352 is actuated a pilot flow arises from the space 503 behind the valve cone 502 towards the first valve port 504 serving as output. Provided that the pressure in the second valve port 506 is higher than that of the first valve port 504, this pilot flow causes the valve cone 502 to move from its closed position and to open the valve. This allows pressurized fluid to flow directly from the first chamber 303a of the cylinder 303 through the second valve port 506 to the first valve port 504. From the first valve port 504, a first volume of the pressurized fluid flow through the actuated, opened third valve arrangement 313 to fill the second chamber 303b of the cylinder 303 as the piston moves in the direction of the arrow B. A second volume of the pressurized fluid flows through the pressure connection 304 to the pump 305, which are driven as motors to recover energy or fluid pressure.

In a second mode the pump 305 is controlled to supply pressurized fluid to actuate the cylinder 303 in the direction of the arrow B. In the first valve arrangement 311, the first and second pilot valves 352, 342 are maintained closed and the valve cone 502 is also kept in closed position as the pressure in the valve port 504 serving as input and in the space 503 is the same. In the valve arrangement 36, a solenoid valve 38 (see FIG. 3) is actuated to provide a pilot flow that causes a valve cone 39 to move from a closed position to an open position and allow flow from the pump 305 to the second chamber 303b of the cylinder 303. Provided the input port pressure, supplied from the pump 305, is higher than the output port pressure, in the second chamber 303b, the valve cone 39 will open. This allows pressurized fluid to flow directly from the input port to the output port of the valve arrangement 36 into the first chamber 303a of the cylinder 303. At the same time the second valve arrangement 35 is actuated to allow fluid to be drained to the tank 34. This is achieved by means of a solenoid actuated 2-port valve. When the solenoid actuated valve is opened, a seat valve is moved to an open position to allow fluid to flow directly from the first chamber 303a to the tank 34.

In the example shown in FIG. 5, a valve arrangement 312 according to the invention is used to provide a fail-safe actuation of the cylinder 303 in case the pressure in the output port is higher than that of the input port.

1. Method for controlling a fluid valve arrangement comprising: a fluid conduit arrangement having a first conduit and a second conduit, the first and the second conduits being connectable with a fluid consumer; a supply connection arrangement having a pressure connection and a tank connection, a first valve arrangement operable to accomplish at least one of closing the pressure connection and connecting the pressure connection in a controlled manner with the first conduit, a second valve arrangement operable to accomplish at least one of closing the pressure connection and connecting the pressure connection in a controlled manner with the first conduit, a third valve arrangement operable to accomplish at least one of closing the tank connection and connecting the tank connection in a controlled manner with the first conduit, a fourth valve arrangement operable to accomplish at least one of closing the tank connection and connecting the tank connection in a controlled manner with the second conduit, and a control device, which controls the valve arrangements the method comprises the steps of
detecting output signals from opening degree sensors connected across at least the first and second valve arrangements
transmitting the output signals to the control device, which control device is arranged for controlling the valve arrangements in response to signals received from each opening degree sensor
determining at least the direction of a pressure drop across at least the first and second valve arrangements, using the said output signals, and
determining an operating mode for each valve arrangement based on the output signals from the opening degree sensors and an input signal from a control unit for the fluid consumer.

2. Method according to claim 1, further comprising the step of determining the magnitude and direction of said pressure drop using an opening degree sensor in a constant pressure valve connected across said valve arrangements.

3. Method according to claim 2, further comprising the step of determining the magnitude and direction of said pressure drop by detecting the position of a spool in the constant pressure valve.

4. Method according to claim 2, further comprising the step of determining a non-linear correlation between the position of the spool and the opening degree of the valve arrangement.

5. Method according to claim 1, further comprising the steps of determining if the pressure in the pressure connection is sufficient for actuating the fluid consumer, and, if the pressure is insufficient, increasing the pressure in the pressure connection,

6. Method according to claim 1, further comprising the steps of determining if the pressure in the conduit to be drained from the fluid consumer is greater than the pressure in the pressure connection, and, if the pressure from the fluid consumer is greater, returning fluid to the pressure connection during actuating the fluid consumer.

7. A fluid valve arrangement comprising: a fluid conduit arrangement having a first conduit and a second conduit, the first and the second conduits being connectable with a fluid consumer; a supply connection arrangement having a pressure connection and a tank connection, a first valve arrangement operable to accomplish at least one of closing the pressure connection and connecting the pressure connection in a controlled manner with the first conduit, a second valve arrangement operable to accomplish at least one of closing the pressure connection and connecting the pressure connection in a controlled manner with the first conduit, a third valve arrangement operable to accomplish at least one of closing the tank connection and connecting the tank connection in a controlled manner with the first conduit, a fourth valve arrangement operable to accomplish at least one of closing the tank connection and connecting the tank connection in a controlled manner with the second conduit, and a control device, which controls the valve arrangements, at least the first and the second valve arrangement is provided with at least one opening degree sensor connected with the control device, and that the control device is operable to control the valve arrangements in response to signals received from each opening degree sensor which signals are proportional to the magnitude and direction of a pressure drop across at least the first and second valve arrangements.

8. A fluid valve arrangement according to claim 7, wherein each opening degree sensor is part of a constant pressure valve connected across said at least the first and second valve arrangements.

9. A fluid valve arrangement according to claim 8, that wherein the constant pressure valve comprises a spool valve and the opening degree sensor is a position sensor, which determines a position of a spool.

10. A fluid valve arrangement according to claim 9, wherein the control device evaluates a non-linear correlation between the position of the spool and the opening degree of the valve arrangement.

11. A fluid valve arrangement according to claim 7, wherein the control device is arranged to determine if the pressure in the first or second conduit is greater than the pressure in the supply connection and to be operable to select a regenerative mode during operation of the fluid consumer.

12. A fluid valve arrangement according to claim 7, wherein each of the third and fourth valve arrangements are provided with an opening degree sensor, connected with the control device.

13. A fluid valve arrangement according to claim 12, wherein each opening degree sensor is part of a constant pressure valve connected across said third and fourth valve arrangements.

14. A fluid valve arrangement according to claim 7, wherein each valve arrangement comprises a first controllable valve operable to allow fluid flow to the fluid consumer, and a second controllable valve operable to allow fluid flow from the fluid consumer.

15. A fluid valve arrangement according to claim 14, wherein each controllable valve is a solenoid operated two-way valve.

16. A fluid valve arrangement according to claim 7, wherein at least the first and the second valve arrangement each comprises a two stage proportional flow control valve, connecting the fluid consumer to the supply connection, which proportional flow control valve has a first and a second pilot circuit each comprising a pilot valve and an opening degree sensor connected with the control device, and that the control device is operable to control the pilot valves in response to signals received from each opening degree sensor which signals are proportional to the magnitude and direction of a pressure drop across at least the first and second pilot valves.

17. A fluid valve arrangement according to claim 16, wherein each opening degree sensor is part of a constant pressure valve connected across said at least the first and second valve arrangements.

18. A fluid valve arrangement according to claim 16 wherein each of the third and fourth valve arrangements are provided with a proportional flow control valve, connecting the fluid consumer to the tank connection, which proportional flow control valve has a first and a second pilot circuit each comprising a pilot valve and an opening degree sensor connected with the control device.
